(19) United States
(12) Patent Application Publication
(10) Pub. No.: US 2025/0105890 A1
(43) Pub. Date: Mar. 27, 2025

(54) ANTENNA GROUP POWER LEVEL CAPABILITY INFORMATION

(71) Applicant: QUALCOMM Incorporated, San Diego, CA (US)

(72) Inventors: Yi HUANG, San Diego, CA (US); Jae Ho RYU, San Diego, CA (US); Enoch Shiao-Kuang LU, San Diego, CA (US); Jianming ZHU, Acton, MA (US)

(21) Appl. No.: 18/735,088

(22) Filed: Jun. 5, 2024

Related U.S. Application Data
(60) Provisional application No. 63/584,724, filed on Sep. 22, 2023.

(51) Int. Cl. H04B 7/0456; H04W 72/51

(52) U.S. Cl. CPC H04B 7/0465; H04W 72/51

(57) ABSTRACT

Various aspects of the present disclosure generally relate to wireless communication. In some aspects, a user equipment (UE) may transmit capability information that indicates a power-level capability of each antenna group, of multiple antenna groups, wherein each antenna group is associated with one or more transmission antennas of at least eight transmission antennas associated with the UE. The UE may receive a scheduling communication that schedules an uplink communication using a selected precoder based at least in part on the capability information. Numerous other aspects are described.

### CROSS-REFERENCE TO RELATED APPLICATION

This patent application claims priority to U.S. Provisional Patent Application No. 63/584,724, filed on Sep. 22, 2023, entitled “ANTENNA GROUP POWER LEVEL CAPABILITY INFORMATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for antenna group power level capability information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting capability information that indicates a power-level capability of each antenna group, of multiple antenna groups, wherein each antenna group is associated with one or more transmission antennas of at least eight transmission antennas associated with the UE. The method may include receiving a scheduling communication that schedules an uplink communication using a selected precoder based at least in part on the capability information.

Some aspects described herein relate to a method of wireless communication performed by a network node. The method may include receiving, from a UE, capability information that indicates a power-level capability of each antenna group, of multiple antenna groups, wherein each antenna group is associated with one or more transmission antennas of at least eight transmission antennas associated with the UE. The method may include selecting a precoder associated with an uplink communication based at least in part on the capability information. The method may include transmitting, to the UE, a scheduling communication that schedules the uplink communication and that indicates the selected precoder.

Some aspects described herein relate to an apparatus for wireless communication. The apparatus may include one or more memories and one or more processors coupled to the one or more memories. The one or more processors may be individually or collectively configured to transmit capability information that indicates a power-level capability of each antenna group, of multiple antenna groups, wherein each antenna group is associated with one or more transmission antennas of at least eight transmission antennas associated with the apparatus. The one or more processors may be individually or collectively configured to receive a scheduling communication that schedules an uplink communication using a selected precoder based at least in part on the capability information.

Some aspects described herein relate to an apparatus for wireless communication. The apparatus may include one or more memories and one or more processors coupled to the one or more memories. The one or more processors may be individually or collectively configured to receive, from a UE, capability information that indicates a power-level capability of each antenna group, of multiple antenna groups, wherein each antenna group is associated with one or more transmission antennas of at least eight transmission antennas associated with the UE. The one or more processors may be individually or collectively configured to select a precoder associated with an uplink communication based at least in part on the capability information. The one or more processors may be individually or collectively configured to transmit, to the UE, a scheduling communication that schedules the uplink communication and that indicates the selected precoder.

Some aspects described herein relate to a non-transitory computer-readable medium that stores a set of instructions for wireless communication by a UE. The set of instructions, when executed by one or more processors of the UE, may cause the UE to transmit capability information that indicates a power-level capability of each antenna group, of multiple antenna groups, each antenna group being associated with one or more transmission antennas of at least eight transmission antennas associated with the UE. The set of instructions, when executed by one or more processors of the UE, may cause the UE to receive a scheduling communication that schedules an uplink communication using a selected precoder based at least in part on the capability information.

Some aspects described herein relate to a non-transitory computer-readable medium that stores a set of instructions for wireless communication by a network node. The set of instructions, when executed by one or more processors of the network node, may cause the network node to receive, from a UE, capability information that indicates a power-level capability of each antenna group, of multiple antenna groups, each antenna group being associated with one or more transmission antennas of at least eight transmission antennas associated with the UE. The set of instructions, when executed by one or more processors of the network node, may cause the network node to select a precoder associated with an uplink communication based at least in part on the capability information. The set of instructions, when executed by one or more processors of the network node, may cause the network node to transmit, to the UE, a scheduling communication that schedules the uplink communication and that indicates the selected precoder.

Some aspects described herein relate to an apparatus for wireless communication. The apparatus may include means for transmitting capability information that indicates a power-level capability of each antenna group, of multiple antenna groups, each antenna group being associated with one or more transmission antennas of at least eight transmission antennas associated with the apparatus. The apparatus may include means for receiving a scheduling communication that schedules an uplink communication using a selected precoder based at least in part on the capability information.

Some aspects described herein relate to an apparatus for wireless communication. The apparatus may include means for receiving, from a UE, capability information that indicates a power-level capability of each antenna group, of multiple antenna groups, each antenna group being associated with one or more transmission antennas of at least eight transmission antennas associated with the UE. The apparatus may include means for selecting a precoder associated with an uplink communication based at least in part on the capability information. The apparatus may include means for transmitting, to the UE, a scheduling communication that schedules the uplink communication and that indicates the selected precoder.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating two examples of forming a virtual antenna port by combining non-coherent and/or partially-coherent antenna ports, in accordance with the present disclosure.

FIGS. 5A-5B are diagrams of an example associated with antenna group power level capability information, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a network node or an apparatus of a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

A user equipment (UE) may be configured to transmit uplink communications using multiple transmission antennas and/or antenna ports. For example, a UE may be configured to transmit uplink communications using four transmission antennas and/or antenna ports (sometimes referred to as a 4 Tx UE), or eight transmission antennas and/or antenna ports (sometimes referred to an 8 Tx UE), among other examples. A UE with more than four transmission antenna ports, such as an 8 Tx UE, may not be able to efficiently signal to a network (e.g., a network node) which precoders may be used to support full-power transmissions by the UE. More particularly, for an 8 Tx UE or a similar UE, a wireless communication standard (e.g., a wireless communication standard promulgated by the Third Generation Partnership Project (3GPP)) may specify numerous (e.g., thousands) of candidate precoders that may be used by the 8 Tx UE. Thus, unreasonably high signaling overhead may be needed to indicate which precoders and/or subsets of the precoders may be used to support full-power transmissions by the UE. Accordingly, to avoid unreasonably high signaling overhead, full-power capability information may not be shared between a UE and a network node, which may result in a network node selecting a precoder that does not support full-power transmissions and/or the UE and the network node communicating using low-power transmissions, leading to degraded signaling between the network node and the UE, increased communication errors between the network node and the UE, and thus high power, computing, and network resource consumption by the network node and the UE for correcting communication errors.

Some techniques and apparatuses described herein enable a UE (e.g., an 8 Tx UE) to provide full-power capability information to a network node with reduced signaling overhead. In some aspects, a UE may report, to a network node, a power level that each antenna group, of multiple antenna groups associated with the UE, can achieve. For example, in some aspects, the UE may transmit, and the network node may receive, capability information that indicates a power-level capability of each antenna group, of multiple antenna groups associated with the UE. In some aspects, the UE may be an 8 Tx UE, and the multiple antenna groups may include four groups of one or more of the eight antenna ports. For each antenna group, the UE may indicate a power level that the antenna group is capable of achieving, such as one of a full-power level, a one-half-full-power level, or a one-quarter-full-power level. The network node may select a precoder based at least in part on the capability information, such as by selecting a precoder that is capable of supporting full-power transmissions, and the network node may signal the selected precoder to the UE. In this way, unreasonably high signaling overhead may be reduced without requiring the network node and/or the UE to forgo full-power capability signaling. This may result in robust communications between the network node and the UE and/or decreased communication errors between the network node and the UE, and thus reduced power, computing, and network resource consumption that would otherwise be required to correct communication errors.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

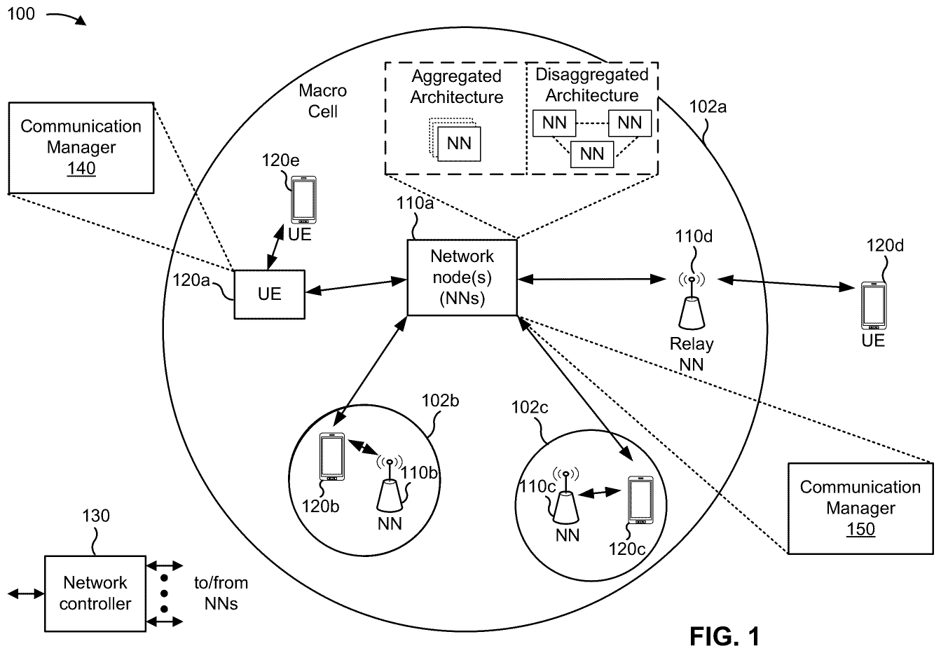

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the 3GPP, the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit capability information that indicates a power-level capability of each antenna group, of multiple antenna groups, wherein each antenna group is associated with one or more transmission antennas of at least eight transmission antennas associated with the UE; and receive a scheduling communication that schedules an uplink communication using a selected precoder based at least in part on the capability information. Additionally, or alternatively, the communication manager 140 may perform one or more other operations described herein.

In some aspects, the network node 110 may include a communication manager 150. As described in more detail elsewhere herein, the communication manager 150 may receive, from a UE, capability information that indicates a power-level capability of each antenna group, of multiple antenna groups, wherein each antenna group is associated with one or more transmission antennas of at least eight transmission antennas associated with the UE; select a precoder associated with an uplink communication based at least in part on the capability information; and transmit, to the UE, a scheduling communication that schedules the uplink communication and that indicates the selected precoder. Additionally, or alternatively, the communication manager 150 may perform one or more other operations described herein.

As indicated above, FIG. 1 is provided as an example. Other examples may differ from what is described with regard to FIG. 1.

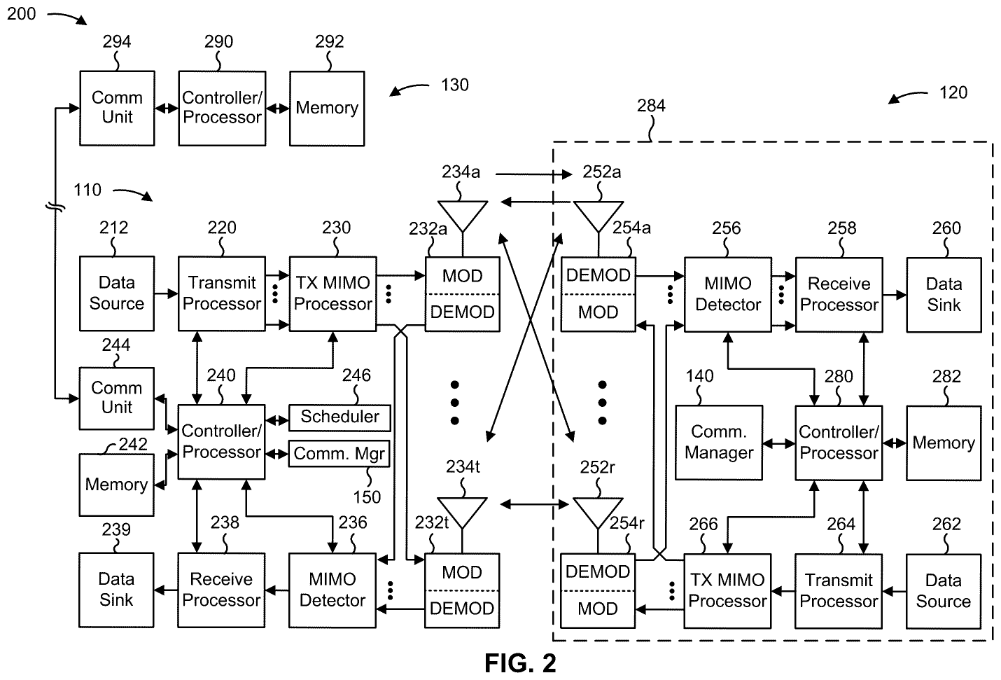

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

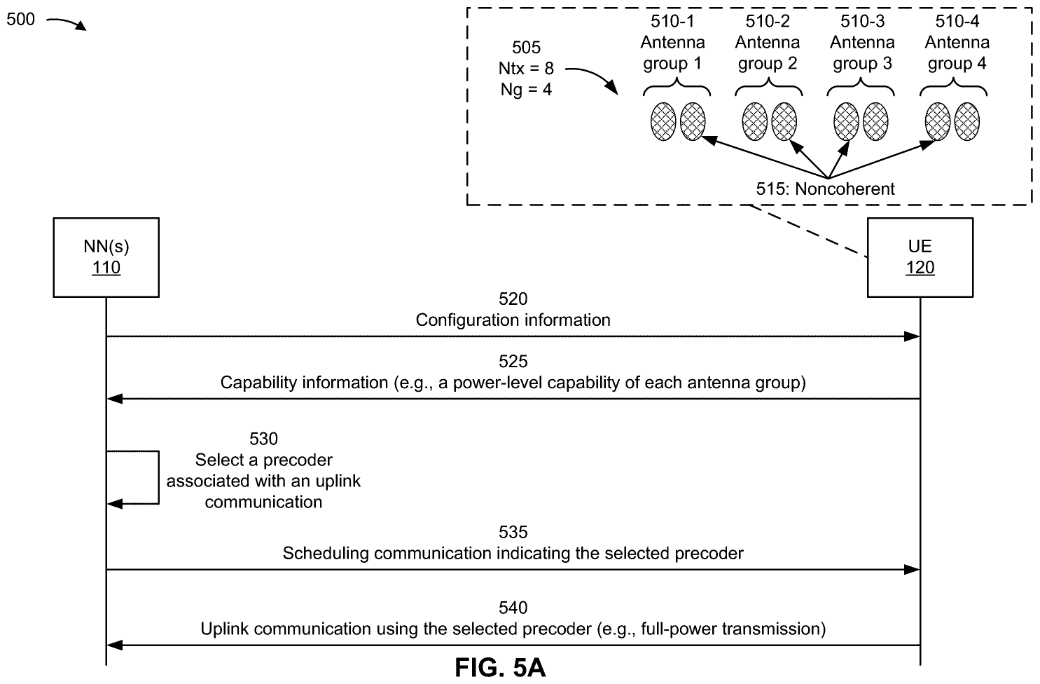

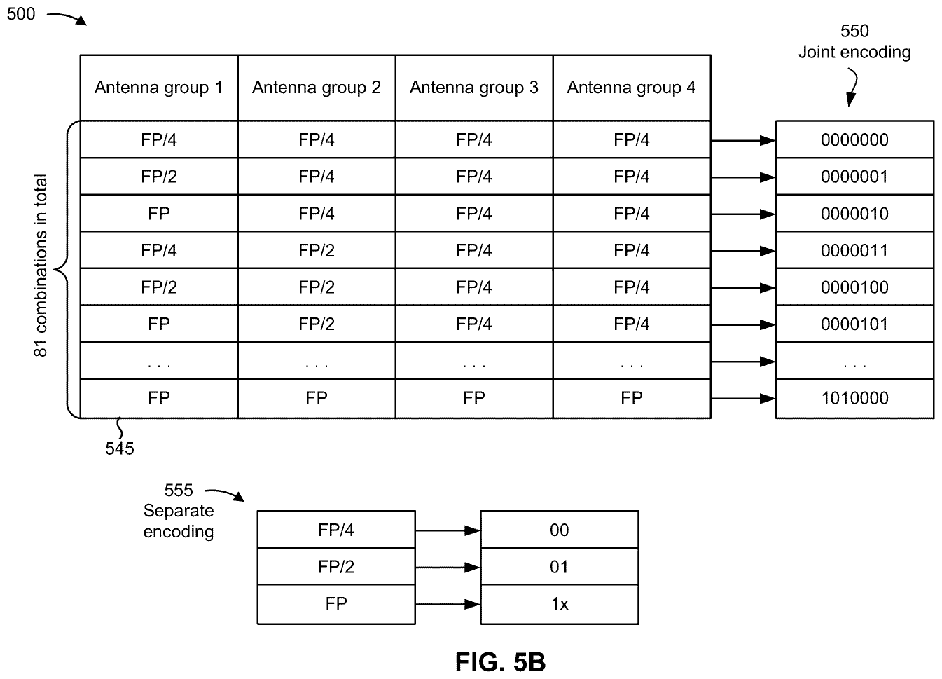

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-9).

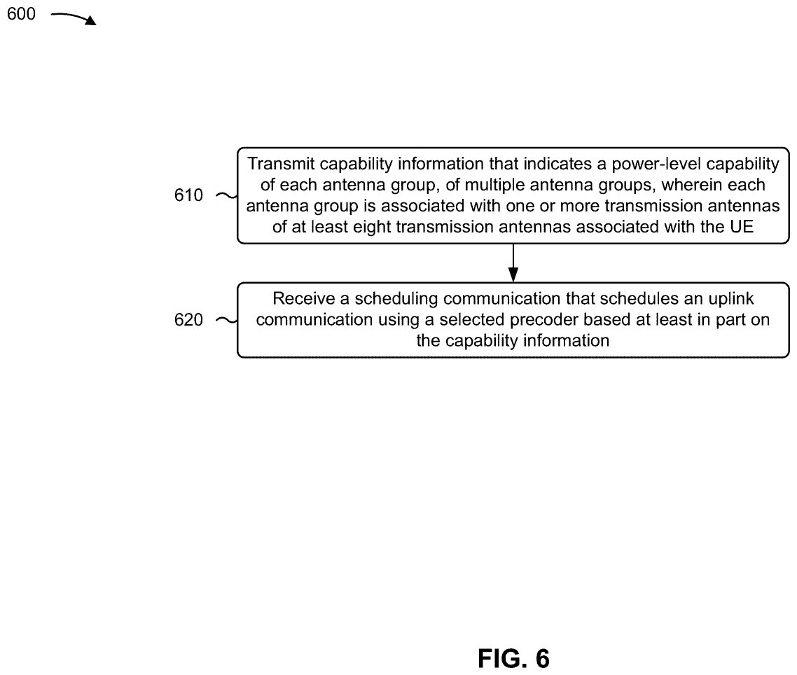

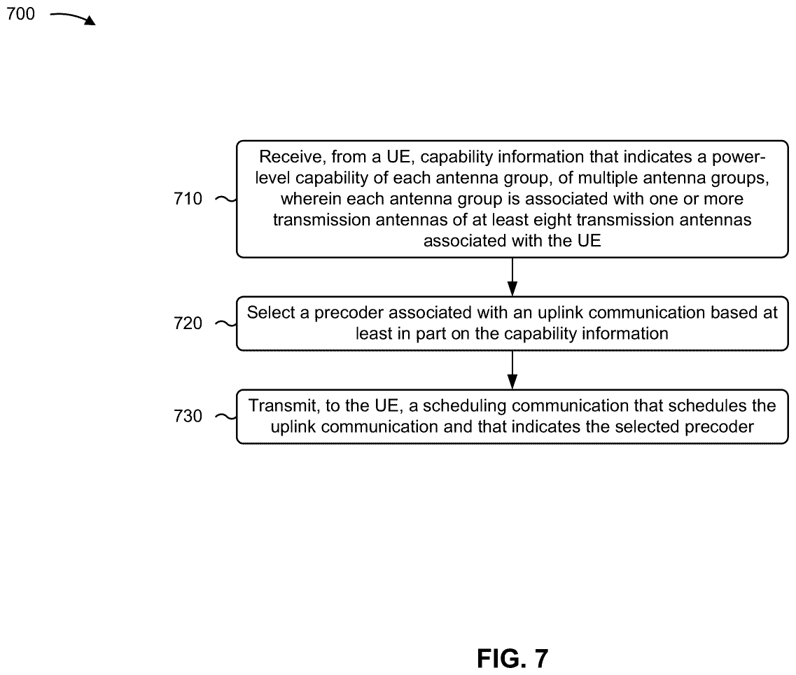

The controller/processor 240 of the network node 110, the controller/processor 280 of the UE 120, and/or any other component(s) of FIG. 2 may perform one or more techniques associated with antenna group power level capability information, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for transmitting capability information that indicates a power-level capability of each antenna group, of multiple antenna groups, wherein each antenna group is associated with one or more transmission antennas of at least eight transmission antennas associated with the UE; and/or means for receiving a scheduling communication that schedules an uplink communication using a selected precoder based at least in part on the capability information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a UE, capability information that indicates a power-level capability of each antenna group, of multiple antenna groups, wherein each antenna group is associated with one or more transmission antennas of at least eight transmission antennas associated with the UE; means for selecting a precoder associated with an uplink communication based at least in part on the capability information; and/or means for transmitting, to the UE, a scheduling communication that schedules the uplink communication and that indicates the selected precoder. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

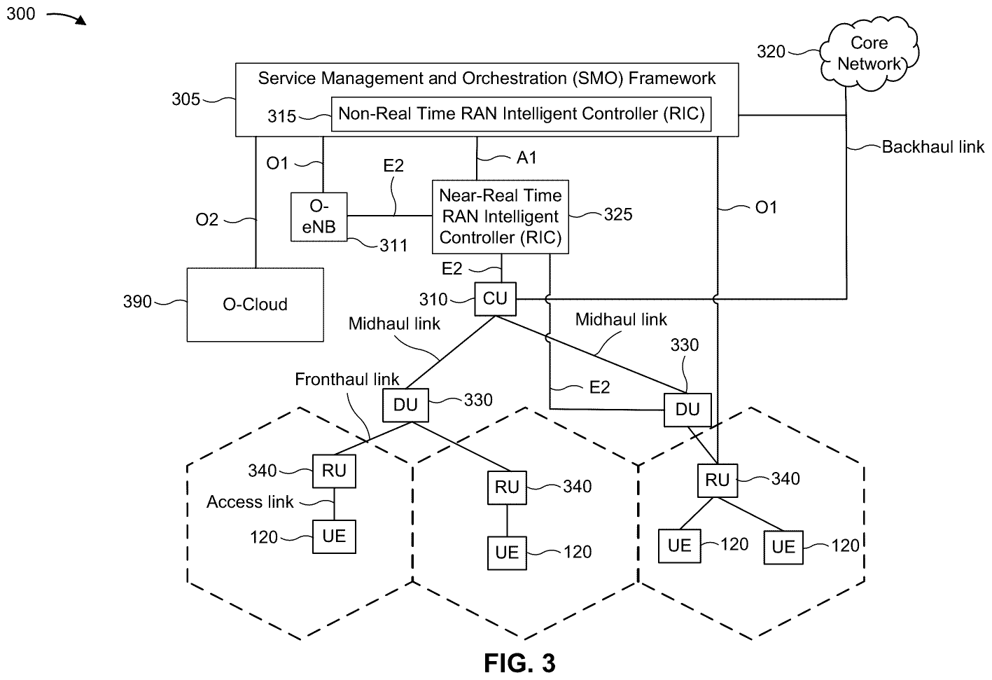

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

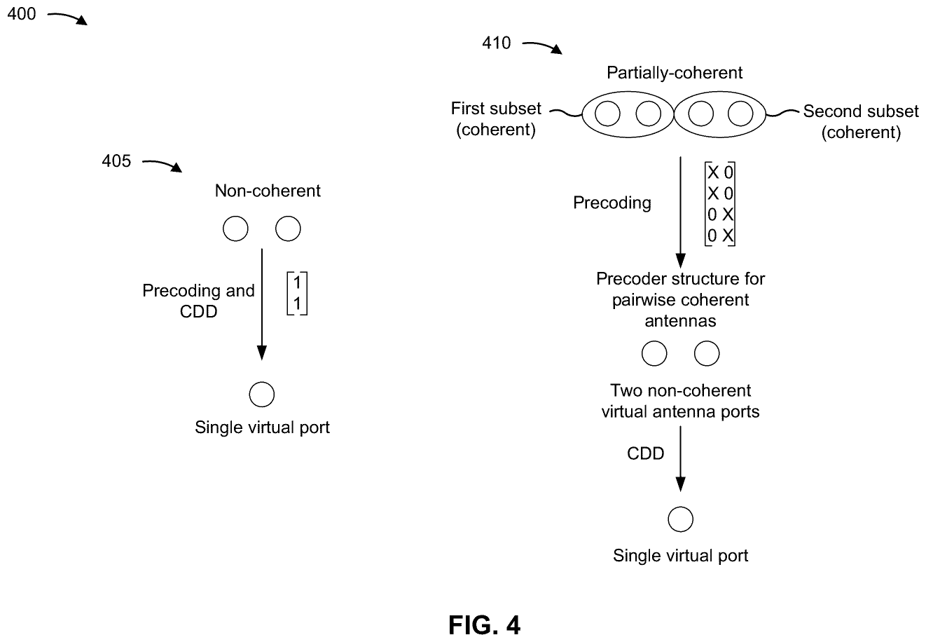

FIG. 4 is a diagram illustrating two examples 400 of forming a virtual antenna port by combining non-coherent and/or partially-coherent antenna ports, in accordance with the present disclosure.

The antennas of a multi-antenna wireless communication device, such as a UE (e.g., UE 120), may be classified into one of three groups depending on coherence of the antenna ports of the UE. A set of antenna ports (for example, two antenna ports) are coherent if the relative phase among the set of antenna ports (for example, between the two antenna ports) remains the same between the time of a sounding reference signal (SRS) transmission from those antenna ports and a subsequent physical uplink shared channel (PUSCH) transmission from those antenna ports. In this case, the SRS may be used (for example, by the UE or a network node) to determine an uplink precoder for precoding the PUSCH transmission, because the relative phase of the antenna ports will be the same for the SRS transmission and the PUSCH transmission. The precoding may span across the set of coherent antenna ports.

If a set of antenna ports is non-coherent, then such uplink precoder determination becomes difficult, because the relative phase between the antenna ports will change from the SRS transmission to the PUSCH transmission. For example, a set of antenna ports is considered non-coherent if the relative phase among the set of antenna ports is different for the SRS transmission than for the PUSCH transmission. In this case, the use of the same uplink precoder for a set of non-coherent antenna ports may result in the UE applying improper or inaccurate precoding weights (such as phase and gain weights) to the data streams transmitted from the non-coherent antenna ports. Furthermore, a set of antenna ports is considered partially-coherent if a first subset of the set of antenna ports is coherent with one another and a second subset of the set of antenna ports is coherent with one another, but the first subset of antenna ports and the second subset of antenna ports are not coherent with one another. In this case, common precoding may be used within each of the respective subsets of coherent antenna ports, but not across the different subsets of non-coherent antenna ports.

In some cases, when a network node schedules a PUSCH transmission for a multi-antenna UE having non-coherent or partially-coherent antenna ports, the signaling communication that schedules the PUSCH transmission may identify an uplink precoder that is to be used to precode the PUSCH transmission. Conventionally, because the antenna ports of the UE are non-coherent (or, in the case of partially coherent antenna ports, are non-coherent groups of coherent antenna ports), the UE may be capable of using the uplink precoder for only one of the antenna ports (or antenna port groups) while other antenna ports (or antenna port groups) are not used for the PUSCH transmission. Because only a subset of non-coherent or partially coherent antenna ports are used, this may result in decreased transmit power of the PUSCH transmission, decreased reliability of the PUSCH transmission (due to lack of transmit or spatial diversity), or the like.

To utilize some or all of the non-coherent or partially coherent antenna ports, the UE may apply various techniques to synthesize non-coherent or partially coherent antenna ports into a virtual antenna port so that common precoding may be used on the virtual antenna port and applied across the non-coherent antenna ports. A virtual (or logical) antenna port may represent a combination of two or more antenna ports. This allows a network node to select an uplink precoder for the virtual antenna port, and allows the UE to use the uplink precoder to transmit on the otherwise non-coherent or partially coherent antenna ports that have been combined to form the virtual antenna port.

For example, as shown by reference number 405, a set of non-coherent antenna ports (e.g., shown as two non-coherent antenna ports) can be combined into a single virtual port using precoding (e.g., uplink precoding) and cyclic delay diversity. The precoder may be determined by the UE 120 and/or signaled by a network node 110. Cyclic delay diversity (CDD) may refer to a technique where a delay (e.g., a cyclic delay) is introduced on one of the non-coherent antenna ports and not the other non-coherent antenna port. In some examples, the delay may be measured in samples (e.g., 5 samples, 10 samples, or another quantity of samples) or fractions of samples. For example, a first non-coherent antenna port may transmit a first stream of samples, and the second non-coherent antenna port may transmit a second stream of samples (e.g., which may be the same stream) with a slight cyclic delay (e.g., a delay of 5 samples, 10 samples, or another quantity of samples). For example, for a cyclic delay of 5 samples, where 16 samples are transmitted per symbol, the first non-coherent antenna port may transmit the 16 samples with a first sample transmitted first (e.g., [s1, s2, s3, s4, . . . , s16]), and the second non-coherent antenna port may transmit the 16 samples with the first sample transmitted sixth (e.g., with a delay of five samples) (e.g., [s12, s13, s14, s15, s16, s1, s2, s3, . . . , s11]).

Additionally, or alternatively, as shown by reference number 410, a set of partially-coherent antenna ports can be combined into a single virtual antenna port using precoding (e.g., uplink precoding) and cyclic delay diversity, in a similar manner as described above. As shown, a first subset of antenna ports may be coherent with one another, and a second subset of antenna ports may be coherent with one another, but the two subsets may not be coherent with one another. As further shown, precoding may be applied to the individual subsets to generate a first virtual antenna port and a second virtual antenna port that are not coherent with one another. Then, CDD may be applied to these two virtual antenna ports (e.g., by transmitting communications from the virtual antenna ports using CDD), thereby forming a single virtual antenna port from the partially-coherent antenna ports (e.g., using precoding and CDD).

Although FIG. 4 shows pairs of antenna ports in sets and subsets, in some aspects, a different number of antenna ports may be included in a set or a subset. For example, a set of antenna ports or subset of antenna ports may include three antenna ports, four antenna ports, or another quantity of antenna ports. Moreover, although FIG. 4 shows an example in which four transmission (“Tx”) antenna ports are associated with a UE 120 (e.g., a 4 Tx UE), in some other examples, a UE 120 may be associated with a different quantity of antenna ports. For example, a UE 120 may be associated with eight transmission antenna ports (e.g., an 8 Tx UE).

In some examples, a UE 120 associated with multiple transmission chains and/or antenna ports (e.g., a 4 Tx UE) may be capable of operating in one of three full-power modes. In a first full-power mode (sometimes referred to as Mode 0), a UE 120 may have a full-power capability (e.g., a full-power power amplifier (PA) capability) on each transmission chain, such as a full-power PA capability on each of the four transmission chains associated with a 4 Tx UE. In some examples, “full power” may be defined relative to a power class of the corresponding UE 120. For example, for a power class 3 UE, full power may correspond to 23 decibels per milliwatt (dBm). For a power class 2 UE, full power may correspond to 26 dBm. And for a power class 1 UE, full power may correspond to 29 dBm. Moreover, a given UE 120 may be associated with a different power class in different frequency bands. For example, a UE 120 may be associated with a first power class in a frequency division duplex (FDD) band (e.g., the UE 120 may be a power class 2 UE in a FDD band) and may be associated with a second power class, different from the first power class, in a time division duplex (TDD) band (e.g., the UE 120 may a power class 3 UE in a TDD band).

In some other examples, due to differing PA capabilities at the various transmission chains associated with respective antenna ports, a UE 120 may not have a full-power capability on each transmission chain. For example, a UE 120 may be capable of full-power transmission ports using some antenna ports and/or uplink precoders, but may not be capable of full-power transmissions using other antenna ports and/or uplink precoders. Accordingly, in such examples, a UE 120 may operate in a second full-power mode (sometimes referred to as Mode 1) or a third full-power mode (sometimes referred to as Mode 2).

In Mode 1, a UE 120 may be permitted to transmit uplink signals using a small cyclic shift in order to achieve full-power transmissions. In Mode 2, a UE 120 may indicate which uplink precoders may be used to achieve full-power transmissions by the UE 120. More particularly, in Mode 2, a UE 120 may be capable of full-power transmissions using only a subset of candidate uplink precoders. Accordingly, in order to achieve a full-power uplink transmission, a network node 110 may need to select an uplink precoder from the subset of the candidate precoders for which the UE 120 can achieve full-power transmissions. A UE 120 may thus transmit capability information (e.g., a capabilities report) to the network node 110 indicating which subset of precoders support full-power transmission (e.g., based at least in part on the UE 120's PA capability on each transmission chain), and the network node 110 may select a precoder, from the subset of candidate precoders that can support full-power transmission, when a full-power uplink transmission is desired.

In some examples, a wireless communication standard (e.g., a wireless communication standard promulgated by the 3GPP) may define subsets of precoders (sometimes referred to as transmitted precoding matrix indicator (TPMI) groups), such as seven subsets of precoders indexed as G0 through G7 for a 4 Tx UE. Some of the subsets of precoders (e.g., some of the TPMI groups) may be associated with non-coherent transmissions (e.g., TPMI groups G0 through G3 may be associated with non-coherent transmissions), while others of the subsets of precoders may be associated with partially coherent transmissions (e.g., TPMI groups G4 through G6 may be associated with non-coherent transmissions). Accordingly, a 4 Tx UE may indicate, to a network node 110, a full-power capability of the UE 120 by indicating (e.g., in a capabilities report) which subset of precoders (e.g., which TPMI group) may be used by the UE 120 for full-power transmissions.

A UE 120 with more than four transmission antenna ports, such as an 8 Tx UE, may not be able to efficiently signal to a network node 110 which precoders may be used to support full-power transmissions. More particularly, for an 8 Tx UE or a similar UE, a wireless communication standard (e.g., a wireless communication standard promulgated by the 3GPP) may specify numerous (e.g., thousands) of candidate precoders that may be used by the 8 Tx UE for uplink transmissions. Organizing thousands of precoders into subsets of precoders that may support full-power transmission according to different PA capabilities of 8 Tx UEs may result in a prohibitively large quantity of subsets of precoders (e.g., TPMI groups), and thus unreasonably high signaling overhead for indicating which one or more subsets, of the numerous subsets of precoders, may be used to support full-power transmissions by the UE 120. Accordingly, to avoid unreasonably high signaling overhead, full-power capability information may not be shared between a network node 110 and the UE 120, which may result in a network node 110 selecting a precoder that does not support full-power transmissions, leading to degraded signaling between the network node 110 and the UE 120, increased communication errors between the network node 110 and the UE 120, and thus high power, computing, and network resource consumption to correct communication errors between the UE 120 and the network node 110.

Some techniques and apparatuses described herein enable a UE 120 to provide full-power capability information to a network node 110 with reduced signaling overhead. In some aspects, a UE 120 may report, to a network node 110, a power level that each antenna group, of multiple antenna groups associated with the UE 120, can achieve. For example, in some aspects, the UE 120 may transmit, and the network node 110 may receive, capability information that indicates a power-level capability of each antenna group, of multiple antenna groups associated with the UE 120. In some aspects, the UE 120 may be an 8 Tx UE, and the multiple antenna groups may include four groups of one or more antenna ports. For each antenna group, the UE 120 may indicate whether the antenna group is capable of achieving one of multiple candidate power levels, such as one of a full-power level, a one-half-full-power level, or a one-quarter-full-power level. The network node 110 may select a precoder based at least in part on the capability information, such as a precoder capable of supporting full-power transmissions, and the network node 110 may signal the selected precoder to the UE 120. In this way, unreasonably high signaling overhead may be reduced without requiring the network node 110 and/or the UE 120 to forgo full-power capability signaling. This may result in robust communications between the network node 110 and the UE 120 and/or decreased communication errors between the network node 110 and the UE 120, and thus reduced power, computing, and network resource consumption that would otherwise be required to correct communication errors between the UE 120 and the network node 110.

As indicated above, FIG. 4 is provided as one or more examples. Other examples are possible and may differ from what is described with regard to FIG. 4.

FIGS. 5A-5B are diagrams of an example 500 associated with antenna group power level capability information, in accordance with the present disclosure. As shown in FIG. 5A, a network node 110 (e.g., a CU, a DU, and/or an RU) may communicate with a UE 120. In some aspects, the network node 110 and the UE 120 may be part of a wireless network (e.g., wireless network 100). The UE 120 and the network node 110 may have established a wireless connection prior to operations shown in FIG. 5A.

In some aspects, the UE 120 may be associated with a number of transmission antenna ports and/or a number of transmission chains (shown as “Ntx” in FIG. 5A). For example, in the example shown in FIG. 5A, and as indicated by reference number 505, the UE 120 may be associated with eight transmission antenna ports and/or transmission chains (e.g., the UE 120 may be an 8 Tx UE). Moreover, the UE 120 may be associated with a number of antenna groups (shown as “Ng” in FIG. 5A). For example, as indicated by reference number 505, the UE 120 may be associated with four antenna groups 510 (shown in FIG. 5A as antenna group 510-1 through antenna group 510-4), with each antenna group including two antenna ports. In some aspects, the UE 120 may be a partially coherent UE 120 associated with Ng antenna groups 510. In that regard, and as indicated by reference number 515, the antenna ports within a given antenna group 510 may be coherent, and/or the antenna groups 510 may be noncoherent with respect to each other.

As shown by reference number 520, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC control elements (MAC-CEs), and/or downlink control information (DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to report full-power capability information for one or more antenna groups 510 associated with the UE 120. For example, the configuration information may configure the UE 120 to operate in full-power Mode 2 or a similar full-power mode, and thus the configuration information may configure the UE 120 to indicate to the network node a full-power capability of each antenna group 510 associated with the UE 120 (e.g., antenna group 510-1 through antenna group 510-4). In some aspects, the configuration information may configure the UE 120 to report the full-power capability of each antenna group 510 by reporting a candidate power level (e.g., one of a full-power capability, a one-half-full-power capability, or a one-fourth-full-power capability, among other examples) that each antenna group is capable of supporting. In some aspects, the UE 120 may be configured to report the full-power capability of each antenna group 510 on a per-band basis (e.g., a granularity of a full-power capabilities report may be per-band). In some other aspects, the UE 120 may be configured to report the full-power capability of each antenna group 510 on a per-band-combination basis (e.g., a granularity of a full-power capabilities report may be per-band-combination). In some other aspects, the UE 120 may be configured to report the full-power capability of each antenna group 510 on a per-band, per-band-combination basis (e.g., a granularity of a full-power capabilities report may be per-band, per-band-combination). And in some other aspects, the UE 120 may be configured to report the full-power capability of each antenna group 510 at a per-component-carrier (CC), per-band, per-band-combination basis (e.g., a granularity of a full-power capabilities report may be per-CC, per-band, per-band-combination). Aspects of reporting the full-power capability of each antenna group 510 are described in more detail below in connection with reference number 525 and FIG. 5B.

The UE 120 may configure itself based at least in part on the configuration information. In some aspects, the UE 120 may be configured to perform one or more operations described herein based at least in part on the configuration information.

As shown by reference number 525, the UE 120 may transmit, and the network node 110 may receive, capability information (e.g., a capabilities report). The capability information may indicate whether the UE 120 supports a feature and/or one or more parameters related to the feature. For example, the capability information may indicate a capability and/or parameter for full-power transmission. As another example, the capability information may indicate a capability and/or parameter for 8 Tx UE full-power transmission. One or more operations described herein may be based on capability information. For example, the UE 120 may perform a communication in accordance with the capability information, or may receive configuration information that is in accordance with the capability information. In some aspects, the capability information may indicate UE 120 support for Mode 2 full-power transmissions. For example, the capability information may indicate a full-power capability of each antenna group 510 associated with the UE 120.

More particularly, the UE 120 may transmit, and the network node 110 may receive, capability information that indicates a power-level capability of each antenna group (e.g., antenna group 510) of multiple antenna groups associated with the UE 120. For example, as shown in FIG. 5A, the UE 120 may be an 8 Tx UE associated with eight transmission antennas and/or transmission antenna ports, and thus each antenna group 510 may be associated with one or more transmission antennas of the eight transmission antennas associated with the UE 120. For example, each antenna group 510 may be associated with two transmission antennas, as shown in FIG. 5A. In some aspects, the UE 120 may report the full-power capability of each antenna group 510 on a per-band basis. In some other aspects, the UE 120 may report the full-power capability of each antenna group 510 on a per-band-combination basis. In some other aspects, the UE 120 may report the full-power capability of each antenna group 510 on a per-band, per-band-combination basis. And in some other aspects, the UE 120 may report the full-power capability of each antenna group 510 on a per-CC, per-band, per-band-combination basis.

In some aspects, the capability information may indicate a selected power-level capability, of multiple candidate power-level capabilities, for each antenna group. For example, the multiple candidate power-level capabilities may include a full-power capability, a one-half-full-power capability, or a one-quarter-full-power capability, among other examples. Accordingly, the capability information may indicate whether each antenna group supports one of full-power transmissions, one-half-full-power transmissions, or one-quarter-full-power transmissions. For example, in some aspects the UE 120 may be a power class 3 UE associated with a maximum transmission power of 23 dBm. Accordingly, for each antenna group associated with the UE 120, the capability information may indicate whether the antenna group is capable of supporting 23 dBm transmissions (e.g., full-power transmissions), 20 dBm transmissions (e.g., one-half-full-power transmissions), or 17 dBm transmissions (e.g., one-quarter-full-power transmissions), among other examples. For example, the UE 120 shown in FIG. 5A may report that the first antenna group 510-1 is capable of 23 dBm transmissions, that the second antenna group 510-2 is capable of 20 dBm transmissions, that the third antenna group 510-3 is capable of 20 dBm transmissions, and/or that the fourth antenna group 510-4 is capable of 17 dBm transmissions, among other examples.

In some aspects, the capability information may indicate the power-level capability of each antenna group using a bit string that jointly encodes the power-level capability of each antenna group. For example, a UE 120 that is associated with four antenna groups (e.g., antenna groups 510-1 through 510-4) may report one of three candidate power-level capabilities (e.g., one of a full-power capability, a one-half-full-power capability, or a one-fourth-full-power capability) for each antenna group by indicating one of 81 codepoints. Put another way, a UE 120 associated with four antenna groups, with each antenna group being associated with one of three candidate power-level capabilities, results in 81 different combinations of antenna groups and power levels, and thus a UE 120 may signal one of 81 codepoints (e.g., using a seven-bit bit string) to indicate the specific antenna group/power-level capability combination associated with the UE 120. Aspects of indicating the power-level capability of each antenna group using a bit string that jointly encodes the power-level capability of each antenna group are described in more detail below in connection with reference numbers 545 and 550 in FIG. 5B.

In some other aspects, the capability information may indicate the power-level capability of each antenna group by indicating, for each antenna group, a corresponding bit string that encodes the power-level capability of the antenna group. For example, a UE 120 that is associated with four antenna groups (e.g., antenna groups 510-1 through 510-4) may report one of three candidate power-level capabilities (e.g., one of a full-power capability, a one-half-full-power capability, or a one-fourth-full-power capability) for each antenna group by indicating, for each antenna group, one of three codepoints. Put another way, a UE 120 may signal one of three codepoints (e.g., using a two-bit bit string) for each antenna group to indicate the specific power-level capability for the corresponding antenna group. Aspects of indicating the power-level capability of each antenna group by indicating, for each antenna group, a corresponding bit string that encodes the power-level capability of the antenna group are described in more detail below in connection with reference number 555 in FIG. 5B.

In some aspects, the configuration information described in connection with reference number 520 and/or the capability information described above in connection with reference number 525 may include information transmitted via multiple communications. Additionally, or alternatively, the network node 110 may transmit the configuration information, or a communication including at least a portion of the configuration information, before and/or after the UE 120 transmits the capability information. For example, the network node 110 may transmit a first portion of the configuration information before the capability information, the UE 120 may transmit at least a portion of the capability information, and the network node 110 may transmit a second portion of the configuration information after receiving the capability information.

As indicated by reference number 530, the network node 110 may select a precoder associated with an uplink communication based at least in part on the capability information. For example, in aspects in which the network node 110 is to schedule the UE 120 with a full-power uplink transmission, the network node 110 may select a precoder that will result in the UE 120 transmitting the uplink communication using an antenna group (e.g., one of antenna group 510-1 through antenna group 510-4) that has a full-power capability. For example, returning to the above example in which the UE 120 is a power class 3 UE and the capability information indicates that the first antenna group 510-1 is capable of 23 dBm transmissions (e.g., full-power transmissions), that the second antenna group 510-2 and the third antenna group 510-3 are capable of 20 dBm transmissions (e.g., one-half-full-power transmissions), and that the fourth antenna group 510-4 is capable of 17 dBm transmissions (e.g., one-fourth-full-power transmissions), the network node 110 may select a precoder that will result in the UE 120 transmitting the uplink communication using the first antenna group 510-1, such as for a purpose of achieving a full-power uplink transmission.

Accordingly, as indicated by reference number 535, the network node 110 may transmit, and the UE 120 may receive, a scheduling communication that schedules an uplink communication using the selected precoder based at least in part on the capability information. Moreover, as indicated by reference number 540, the UE 120 may transmit, to the network node 110, the uplink communication using the selected precoder. In this way, the uplink communication may be transmitted by the UE 120 to the network node 110 using a power level selected by the network node 110. For example, in aspects in which a full-power transmission is desired, the UE 120 may achieve a full-power transmission by using a precoder associated with an antenna group that is capable of full-power transmissions.

As shown in FIG. 5B, and as indicated by reference number 545, in some aspects, the UE 120 may be associated with four antenna groups (e.g., antenna groups 510-1 through 510-4), and the capability information may indicate, for each antenna group, one of three candidate power-level capabilities, such as one of a full-power-level capability (shown in FIG. 5B as “FP”), a one-half-full-power-level capability (shown in FIG. 5B as “FP/2”), or a one-quarter-full-power-level capability (shown in FIG. 5B as “FP/4”). In such aspects, there may be 81 candidate antenna group/power-level capability combinations, shown via the rows of the table indicated by reference number 545. For example, a first candidate antenna group/power-level capability combination may correspond to each antenna group having a one-fourth-full-power capability (e.g., {FP/4, FP/4, FP/4, FP/4}), a second candidate antenna group/power-level capability combination may correspond to the first antenna group having a one-half-full-power capability and each remaining antenna group having a one-fourth-full-power capability (e.g., {FP/2, FP/4, FP/4, FP/4}), and so forth, such that an eighty-first candidate antenna group/power-level capability combination may correspond to each antenna group having a full-power capability (e.g., {FP, FP, FP, FP}).

In such aspects, and as indicated by reference number 550, the capability information may indicate the power-level capability of each antenna group using a seven-bit bit string that jointly encodes the power-level capability of each antenna group. More particularly, a seven-bit bit string may be capable of signaling one of 128 (e.g., 2⁷) values, and thus 81 of the 128 bit combinations may correspond to one of the candidate antenna group/power-level capability combinations of the 81 candidate antenna group/power-level capability combinations described above, with the remaining 47 bit combinations being reserved. For example, in the aspects shown in FIG. 5B, a bit string of 000000 may indicate that each antenna group has a one-fourth-full-power capability (e.g., 0000000 may correspond to {FP/4, FP/4, FP/4, FP/4}), a bit string of 0000001 may indicate that the first antenna group has a one-half-full-power capability and each remaining antenna group has a one-fourth-full-power capability (e.g., 0000001 may correspond to {FP/2, FP/4, FP/4, FP/4}), and so forth, such that a bit string of 1010000 may indicate that each antenna group has a full-power capability (e.g., 1010000 may correspond to {FP, FP, FP, FP}).

In some other aspects, and as indicated by reference number 555, the capability information may indicate the power-level capability of each antenna group by indicating, for each antenna group, a corresponding bit string that encodes the power-level capability of the antenna group. For example, in aspects in which the capability information indicates, for each antenna group, one of three candidate power-level capabilities, the bit string may include two bits, which may be capable of indicating one of four (e.g., 2²) values, with one value being reserved. For example, in the aspect shown in connection with reference number 555, a bit string of 00 may correspond to a one-fourth-full-power capability (e.g., FP/4), a bit string of 01 may correspond to a one-half-full-power capability (e.g., FP/2), and/or a bit string of 10 and/or 11 (shown in FIG. 5B as “1x”) may correspond to a full-power capability (e.g., FP).

In that regard, a first bit, of the two bits, may indicate whether the corresponding antenna group is capable of full-power transmission, and the second bit, of the two bits, may indicate whether the antenna group is capable of one of one-half-full-power transmission or one-quarter-full-power transmission. For example, if the bit string begins with bit “1,” the network node 110 may understand that the corresponding antenna group is capable of full-power transmission, and if the bit string begins with bit “0,” the network node 110 may understand that the corresponding antenna group is not capable of full-power transmission. For antenna groups that are not capable of full-power transmission (e.g., for antenna groups for which the bit string begins with “0”), the second bit of the corresponding two-bit bit string may indicate whether the corresponding antenna group is capable of one-half-full-power transmission. For example, if the bit string ends with bit “1” (e.g., 01), the network node 110 may understand that the corresponding antenna group is capable of one-half-full-power transmission, and if the bit string ends with bit “0” (e.g., 00) the network node 110 may understand that the corresponding antenna group is not capable of one-half-full-power transmission (and thus is capable of one-fourth-full-power transmission).

In this regard, indicating the power-level capability of each antenna group using separate encoding (e.g., as shown by reference number 555) may result in increased signaling overhead as compared to indicating the power-level capability of each antenna group using joint encoding (e.g., as shown by reference number 550), because, for four antenna groups and three candidate power-level capabilities, eight total bits may need to be signaled by the UE 120 for separate encoding and only seven total bits may need to be signaled by the UE 120 for joint encoding. However, indicating the power-level capability of each antenna group using separate encoding may result in reduced computing resource consumption by the UE 120 and/or the network node 110 as compared to indicating the power-level capability of each antenna group using joint encoding, because the UE 120 and/or network node 110 may be able to more readily signal and/or interpret the two-bit bit strings without reference to an 81-row lookup table (e.g., the table shown in connection with reference number 545) and/or without performing additional computations that may be associated with the joint encoding aspects.

Based at least in part on the UE 120 signaling, to the network node 110, a full-power capability of each antenna group 510 associated with the UE 120, the UE 120 and/or the network node 110 may conserve computing, power, network, and/or communication resources that may have otherwise been consumed by the network node 110 selecting a precoder for uplink transmissions when the UE 120's full-power capability is transparent to the network node 110. For example, based at least in part on the UE 120 signaling, to the network node 110, a full-power capability of each antenna group 510 associated with the UE 120, the network node 110 may select a precoder that will achieve a full-power transmission, resulting in the UE 120 and the network node 110 communicating with a reduced error rate, and thus the UE 120 and/or the network node 110 may conserve computing, power, network, and/or communication resources that may have otherwise been consumed to detect and/or correct communication errors.

As indicated above, FIGS. 5A-5B are provided as an example. Other examples may differ from what is described with respect to FIGS. 5A-5B.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with antenna group power level capability information.

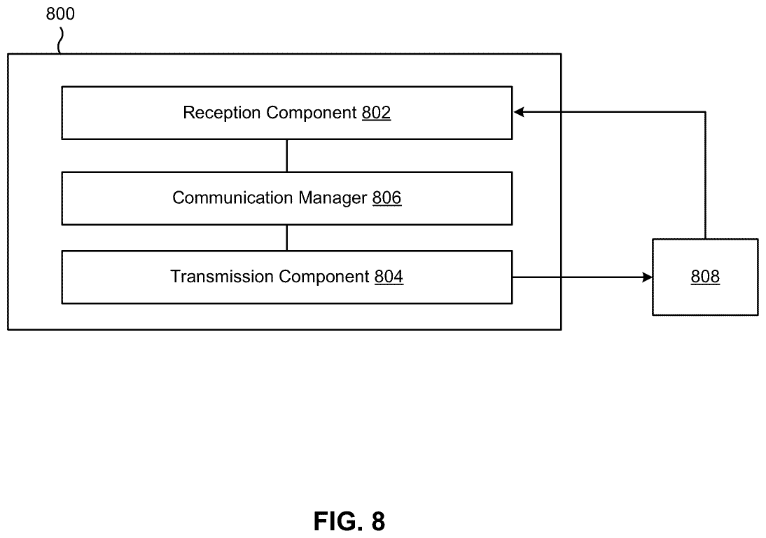

As shown in FIG. 6, in some aspects, process 600 may include transmitting capability information that indicates a power-level capability of each antenna group, of multiple antenna groups, wherein each antenna group is associated with one or more transmission antennas of at least eight transmission antennas associated with the UE (block 610). For example, the UE (e.g., using transmission component 804 and/or communication manager 806, depicted in FIG. 8) may transmit capability information that indicates a power-level capability of each antenna group, of multiple antenna groups, wherein each antenna group is associated with one or more transmission antennas of at least eight transmission antennas associated with the UE, as described above.

As further shown in FIG. 6, in some aspects, process 600 may include receiving a scheduling communication that schedules an uplink communication using a selected precoder based at least in part on the capability information (block 620). For example, the UE (e.g., using reception component 802 and/or communication manager 806, depicted in FIG. 8) may receive a scheduling communication that schedules an uplink communication using a selected precoder based at least in part on the capability information, as described above.

Process 600 may include additional aspects, such as any single aspect or any combination of aspects described below and/or in connection with one or more other processes described elsewhere herein.

In a first aspect, the capability information indicates a selected power-level capability, of multiple candidate power-level capabilities, for each antenna group.

In a second aspect, alone or in combination with the first aspect, the multiple candidate power-level capabilities include a full-power capability, a one-half-full-power capability, and a one-quarter-full-power capability.

In a third aspect, alone or in combination with one or more of the first and second aspects, the capability information indicates the power-level capability of each antenna group using a bit string that jointly encodes the power-level capability of each antenna group.

In a fourth aspect, alone or in combination with one or more of the first through third aspects, the multiple antenna groups include four antenna groups, the capability information indicates, for each antenna group, one of three candidate power-level capabilities, and the bit string that jointly encodes the power-level capabilities of the multiple antenna groups includes seven bits.

In a fifth aspect, alone or in combination with one or more of the first through fourth aspects, the capability information indicates the power-level capability of each antenna group by indicating, for each antenna group, a corresponding bit string that encodes the power-level capability of the antenna group.

In a sixth aspect, alone or in combination with one or more of the first through fifth aspects, the capability information indicates, for each antenna group, one of three candidate power-level capabilities, and, for each antenna group, the corresponding bit string that encodes the power-level capability of the antenna group includes two bits.

In a seventh aspect, alone or in combination with one or more of the first through sixth aspects, a first bit, of the two bits, indicates whether the antenna group is capable of full-power transmission.

In an eighth aspect, alone or in combination with one or more of the first through seventh aspects, a second bit, of the two bits, indicates whether the antenna group is capable of one of one-half-full-power transmission or one-quarter-full-power transmission.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with antenna group power level capability information.

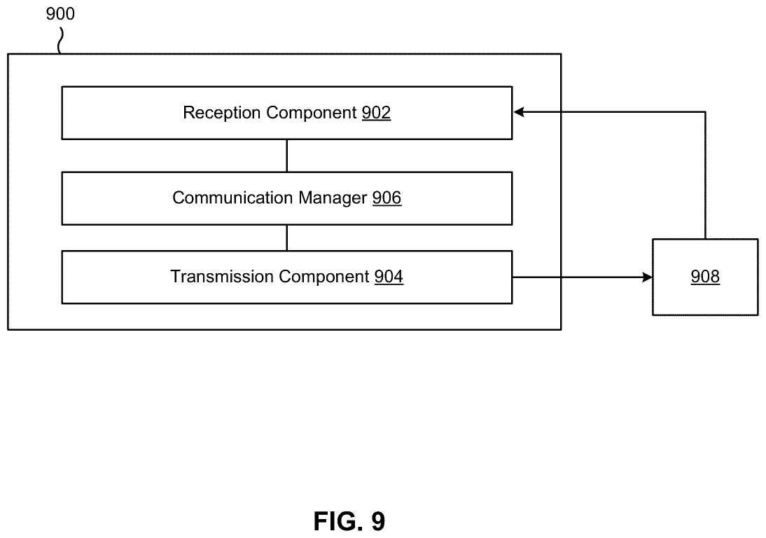

As shown in FIG. 7, in some aspects, process 700 may include receiving, from a UE, capability information that indicates a power-level capability of each antenna group, of multiple antenna groups, wherein each antenna group is associated with one or more transmission antennas of at least eight transmission antennas associated with the UE (block 710). For example, the network node (e.g., using reception component 902 and/or communication manager 906, depicted in FIG. 9) may receive, from a UE, capability information that indicates a power-level capability of each antenna group, of multiple antenna groups, wherein each antenna group is associated with one or more transmission antennas of at least eight transmission antennas associated with the UE, as described above.

As further shown in FIG. 7, in some aspects, process 700 may include selecting a precoder associated with an uplink communication based at least in part on the capability information (block 720). For example, the network node (e.g., using communication manager 906, depicted in FIG. 9) may select a precoder associated with an uplink communication based at least in part on the capability information, as described above.

As further shown in FIG. 7, in some aspects, process 700 may include transmitting, to the UE, a scheduling communication that schedules the uplink communication and that indicates the selected precoder (block 730). For example, the network node (e.g., using transmission component 904 and/or communication manager 906, depicted in FIG. 9) may transmit, to the UE, a scheduling communication that schedules the uplink communication and that indicates the selected precoder, as described above.

Process 700 may include additional aspects, such as any single aspect or any combination of aspects described below and/or in connection with one or more other processes described elsewhere herein.

In a first aspect, the capability information indicates a selected power-level capability, of multiple candidate power-level capabilities, for each antenna group.

In a second aspect, alone or in combination with the first aspect, the multiple candidate power-level capabilities include a full-power capability, a one-half-full-power capability, and a one-quarter-full-power capability.

In a third aspect, alone or in combination with one or more of the first and second aspects, the capability information indicates the power-level capability of each antenna group using a bit string that jointly encodes the power-level capability of each antenna group.

In a fourth aspect, alone or in combination with one or more of the first through third aspects, the multiple antenna groups include four antenna groups, the capability information indicates, for each antenna group, one of three candidate power-level capabilities, and the bit string that jointly encodes the power-level capabilities of the multiple antenna groups includes seven bits.

In a fifth aspect, alone or in combination with one or more of the first through fourth aspects, the capability information indicates the power-level capability of each antenna group by indicating, for each antenna group, a corresponding bit string that encodes the power-level capability of the antenna group.

In a sixth aspect, alone or in combination with one or more of the first through fifth aspects, the capability information indicates, for each antenna group, one of three candidate power-level capabilities, and, for each antenna group, the corresponding bit string that encodes the power-level capability of the antenna group includes two bits.

In a seventh aspect, alone or in combination with one or more of the first through sixth aspects, a first bit, of the two bits, indicates whether the antenna group is capable of full-power transmission.

In an eighth aspect, alone or in combination with one or more of the first through seventh aspects, a second bit, of the two bits, indicates whether the antenna group is capable of one of one-half-full-power transmission or one-quarter-full-power transmission.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 5A-5B. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE 120 described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the UE 120 described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the UE 120 described in connection with FIG. 2. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit capability information that indicates a power-level capability of each antenna group, of multiple antenna groups, wherein each antenna group is associated with one or more transmission antennas of at least eight transmission antennas associated with the UE. The reception component 802 may receive a scheduling communication that schedules an uplink communication using a selected precoder based at least in part on the capability information.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5A-5B. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node 110 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the network node 110 described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the network node 110 described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a UE, capability information that indicates a power-level capability of each antenna group, of multiple antenna groups, wherein each antenna group is associated with one or more transmission antennas of at least eight transmission antennas associated with the UE. The communication manager 906 may select a precoder associated with an uplink communication based at least in part on the capability information. The transmission component 904 may transmit, to the UE, a scheduling communication that schedules the uplink communication and that indicates the selected precoder.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: transmitting capability information that indicates a power-level capability of each antenna group, of multiple antenna groups, wherein each antenna group is associated with one or more transmission antennas of at least eight transmission antennas associated with the UE; and receiving a scheduling communication that schedules an uplink communication using a selected precoder based at least in part on the capability information.

Aspect 2: The method of Aspect 1, wherein the capability information indicates a selected power-level capability, of multiple candidate power-level capabilities, for each antenna group.

Aspect 3: The method of Aspect 2, wherein the multiple candidate power-level capabilities include a full-power capability, a one-half-full-power capability, and a one-quarter-full-power capability.

Aspect 4: The method of any of Aspects 1-3, wherein the capability information indicates the power-level capability of each antenna group using a bit string that jointly encodes the power-level capability of each antenna group.

Aspect 5: The method of Aspect 4, wherein the multiple antenna groups include four antenna groups, wherein the capability information indicates, for each antenna group, one of three candidate power-level capabilities, and wherein the bit string that jointly encodes the power-level capabilities of the multiple antenna groups includes seven bits.

Aspect 6: The method of any of Aspects 1-3, wherein the capability information indicates the power-level capability of each antenna group by indicating, for each antenna group, a corresponding bit string that encodes the power-level capability of the antenna group.

Aspect 7: The method of Aspect 6, wherein the capability information indicates, for each antenna group, one of three candidate power-level capabilities, and wherein, for each antenna group, the corresponding bit string that encodes the power-level capability of the antenna group includes two bits.

Aspect 8: The method of Aspect 7, wherein a first bit, of the two bits, indicates whether the antenna group is capable of full-power transmission.

Aspect 9: The method of Aspect 7, wherein a second bit, of the two bits, indicates whether the antenna group is capable of one of one-half-full-power transmission or one-quarter-full-power transmission.

Aspect 10: A method of wireless communication performed by a network node, comprising: receiving, from a UE, capability information that indicates a power-level capability of each antenna group, of multiple antenna groups, wherein each antenna group is associated with one or more transmission antennas of at least eight transmission antennas associated with the UE; selecting a precoder associated with an uplink communication based at least in part on the capability information; and transmitting, to the UE, a scheduling communication that schedules the uplink communication and that indicates the selected precoder.

Aspect 11: The method of Aspect 10, wherein the capability information indicates a selected power-level capability, of multiple candidate power-level capabilities, for each antenna group.

Aspect 12: The method of Aspect 11, wherein the multiple candidate power-level capabilities include a full-power capability, a one-half-full-power capability, and a one-quarter-full-power capability.

Aspect 13: The method of any of Aspects 10-12, wherein the capability information indicates the power-level capability of each antenna group using a bit string that jointly encodes the power-level capability of each antenna group.

Aspect 14: The method of Aspect 13, wherein the multiple antenna groups include four antenna groups, wherein the capability information indicates, for each antenna group, one of three candidate power-level capabilities, and wherein the bit string that jointly encodes the power-level capabilities of the multiple antenna groups includes seven bits.

Aspect 15: The method of any of Aspects 10-12, wherein the capability information indicates the power-level capability of each antenna group by indicating, for each antenna group, a corresponding bit string that encodes the power-level capability of the antenna group.

Aspect 16: The method of Aspect 15, wherein the capability information indicates, for each antenna group, one of three candidate power-level capabilities, and wherein, for each antenna group, the corresponding bit string that encodes the power-level capability of the antenna group includes two bits.

Aspect 17: The method of Aspect 16, wherein a first bit, of the two bits, indicates whether the antenna group is capable of full-power transmission.

Aspect 18: The method of Aspect 16, wherein a second bit, of the two bits, indicates whether the antenna group is capable of one of one-half-full-power transmission or one-quarter-full-power transmission.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication, comprising:
one or more memories; and
one or more processors coupled to the one or more memories, the one or more processors individually or collectively configured to:
transmit capability information that indicates a power-level capability of each antenna group, of multiple antenna groups, wherein each antenna group is associated with one or more transmission antennas of at least eight transmission antennas associated with the apparatus; and
receive a scheduling communication that schedules an uplink communication using a selected precoder based at least in part on the capability information.

2. The apparatus of claim 1, wherein the capability information indicates a selected power-level capability, of multiple candidate power-level capabilities, for each antenna group.

3. The apparatus of claim 2, wherein the multiple candidate power-level capabilities include a full-power capability, a one-half-full-power capability, and a one-quarter-full-power capability.

4. The apparatus of claim 1, wherein the capability information indicates the power-level capability of each antenna group using a bit string that jointly encodes the power-level capability of each antenna group.

5. The apparatus of claim 4, wherein the multiple antenna groups include four antenna groups,
wherein the capability information indicates, for each antenna group, one of three candidate power-level capabilities, and
wherein the bit string that jointly encodes the power-level capabilities of the multiple antenna groups includes seven bits.

6. The apparatus of claim 1, wherein the capability information indicates the power-level capability of each antenna group by indicating, for each antenna group, a corresponding bit string that encodes the power-level capability of the antenna group.

7. The apparatus of claim 6, wherein the capability information indicates, for each antenna group, one of three candidate power-level capabilities, and
wherein, for each antenna group, the corresponding bit string that encodes the power-level capability of the antenna group includes two bits.

8. The apparatus of claim 7, wherein a first bit, of the two bits, indicates whether the antenna group is capable of full-power transmission.

9. The apparatus of claim 7, wherein a second bit, of the two bits, indicates whether the antenna group is capable of one of one-half-full-power transmission or one-quarter-full-power transmission.

10. A method of wireless communication performed by a user equipment (UE), comprising:
transmitting capability information that indicates a power-level capability of each antenna group, of multiple antenna groups, wherein each antenna group is associated with one or more transmission antennas of at least eight transmission antennas associated with the UE; and
receiving a scheduling communication that schedules an uplink communication using a selected precoder based at least in part on the capability information.

11. The method of claim 10, wherein the capability information indicates a selected power-level capability, of multiple candidate power-level capabilities, for each antenna group.

12. The method of claim 11, wherein the multiple candidate power-level capabilities include a full-power capability, a one-half-full-power capability, and a one-quarter-full-power capability.

13. The method of claim 10, wherein the capability information indicates the power-level capability of each antenna group using a bit string that jointly encodes the power-level capability of each antenna group.

14. The method of claim 13, wherein the multiple antenna groups include four antenna groups,
wherein the capability information indicates, for each antenna group, one of three candidate power-level capabilities, and
wherein the bit string that jointly encodes the power-level capabilities of the multiple antenna groups includes seven bits.

15. The method of claim 10, wherein the capability information indicates the power-level capability of each antenna group by indicating, for each antenna group, a corresponding bit string that encodes the power-level capability of the antenna group.

16. The method of claim 15, wherein the capability information indicates, for each antenna group, one of three candidate power-level capabilities, and
wherein, for each antenna group, the corresponding bit string that encodes the power-level capability of the antenna group includes two bits.

17. The method of claim 16, wherein a first bit, of the two bits, indicates whether the antenna group is capable of full-power transmission.

18. The method of claim 16, wherein a second bit, of the two bits, indicates whether the antenna group is capable of one of one-half-full-power transmission or one-quarter-full-power transmission.

19. A non-transitory computer-readable medium storing a set of instructions for wireless communication, the set of instructions comprising:
one or more instructions that, when executed by one or more processors of a user equipment (UE), cause the UE to:
transmit capability information that indicates a power-level capability of each antenna group, of multiple antenna groups, wherein each antenna group is associated with one or more transmission antennas of at least eight transmission antennas associated with the UE; and
receive a scheduling communication that schedules an uplink communication using a selected precoder based at least in part on the capability information.

20. The non-transitory computer-readable medium of claim 19, wherein the capability information indicates a selected power-level capability, of multiple candidate power-level capabilities, for each antenna group.
